(19) United States
(12) Patent Application Publication
(10) Pub. No.: US 2018/0175339 A1
(43) Pub. Date: Jun. 21, 2018

(54) BATTERY PACK AND POWER SUPPLY DEVICE

(71) Applicant: CALSONIC KANSEI CORPORATION, Saitama-shi, Saitama (JP)

(72) Inventors: Toshiyuki MOTOHASHI, Saitama-shi, Saitama (JP); Satoshi SAKUMA, Saitama-shi, Saitama (JP); Yuuichirou NOMURA, Saitama-shi, Saitama (JP)

(73) Assignee: CALSONIC KANSEI CORPORATION, Saitama-shi, Saitama (JP)

(21) Appl. No.: 15/736,402

(22) PCT Filed: Jun. 21, 2016
(86) PCT No.: PCT/JP2016/002986

§ 371 Date: Dec. 14, 2017

(30) Foreign Application Priority Data
Jun. 22, 2015 (JP) 2015-125023

(51) Int. Cl. H01M 2/10; H01M 10/04

(52) U.S. Cl. CPC H01M 2/1016; H01M 10/045

(57) ABSTRACT

A battery pack and power supply device can be assembled stably. A battery pack (200) according to this disclosure includes a body (240), which includes batteries (250), and a bus bar plate (210) mounted onto the body (240) at fastening points so as to cover electrodes (251) of the batteries (250). The bus bar plate (210) includes openings, and the fastening points are provided on the outer peripheral edge (219) of the bus bar plate (210) at positions near the peripheral edge of the openings.

### CROSS-REFERENCE TO RELATED APPLICATION

The present application claims priority to and the benefit of Japanese Patent Application No. 2015-125023 filed Jun. 22, 2015, the entire contents of which are incorporated herein by reference.

### TECHNICAL FIELD

This disclosure relates to a battery pack and a power supply device.

### BACKGROUND

Some chargeable/dischargeable power supply devices include a plurality of batteries. For example, patent literature (PTL) 1 discloses a chargeable/dischargeable power supply device mounted in a hybrid vehicle, an electric vehicle, or the like. In the power supply device disclosed in PTL 1, a plurality of batteries held by a holding plate are connected via a bus bar, and a duct is formed by mounting a member body onto the holding plate. The power supply device disclosed in PTL 1 adopts a double structure constituted by the duct and a seal member to prevent the gas emitted from the battery during charging and discharging from leaking outside of the power supply device.

### CITATION LIST

### Patent Literature

PTL 1: JP 3934899 B2

### SUMMARY

### Technical Problem

It is difficult, however, to produce the power supply device disclosed in PTL 1 efficiently, since many components need to be assembled. Furthermore, the power supply device disclosed in PTL 1 does not take assembly of components into sufficient consideration, and components are not always assembled together stably. The risk of gas leaking from between components is therefore high, and the seal is not necessarily very reliable.

In light of these considerations, it would be helpful to provide a battery pack and a power supply device that allow stable assembly.

### Solution to Problem

To this end, a battery pack according to a first aspect includes:

a body including a plurality of batteries; and

a bus bar plate mounted onto the body at a fastening point so as to cover electrodes of the batteries, wherein

the bus bar plate comprises an opening, and the fastening point is provided on an outer peripheral edge of the bus bar plate at a position near a peripheral edge of the opening.

In a battery pack according to a second aspect, the opening is a degassing opening provided at a position corresponding to a gas escape hole of the batteries once the bus bar plate is mounted onto the body.

In a battery pack according to a third aspect, the opening is an electrode opening provided at positions corresponding to the electrodes of the batteries once the bus bar plate is mounted onto the body.

In a battery pack according to a fourth aspect, the bus bar plate has a holding claw to hold a bus bar.

In a battery pack according to a fifth aspect, the bus bar plate has a bead on the outer peripheral edge.

In a battery pack according to a sixth aspect, the bus bar plate has a bead on the peripheral edge of the opening.

In a battery pack according to a seventh aspect, at a bus bar arranged across a plurality of the electrode openings, the bus bar plate has a bead on a plate portion between the plurality of the electrode openings.

A battery pack according to an eighth aspect further includes an opening valve cover to be mounted over the degassing opening onto the body along with the bus bar plate at the fastening point.

A power supply device according to a ninth aspect includes the aforementioned battery pack.

### Advantageous Effect

The fastening points in the battery pack according to the first aspect are provided on the outer peripheral edge of the bus bar plate at positions near the peripheral edge of the openings that the bus bar plate has, thereby reducing the distance between the fastening points and the openings as compared to when the fastening points are provided at different positions. Therefore, the bus bar plate can be stably mounted onto the body at the opening portion.

The battery pack according to the second aspect allows the bus bar plate to be stably mounted onto the body at the degassing opening portion of the bus bar plate.

The battery pack according to the third aspect allows the bus bar plate to be stably mounted onto the body at the electrode opening portion of the bus bar plate.

With the battery pack according to the fourth aspect, the bus bar is temporarily held to the bus bar plate when assembling the battery pack, thereby facilitating assembly of the battery pack.

The battery pack according to the fifth aspect increases the rigidity of the bus bar plate at the outer peripheral edge that has the bead. As a result, the overall rigidity of the battery pack on which the bus bar plate is mounted increases.

The battery pack according to the sixth aspect increases the rigidity of the bus bar plate at the peripheral edge of the opening that has the bead. As a result, the overall rigidity of the battery pack on which the bus bar plate is mounted increases.

The battery pack according to the seventh aspect increases the rigidity of the bus bar plate at the plate portion that has the bead. As a result, the overall rigidity of the battery pack on which the bus bar plate is mounted increases.

With the battery pack according to the eighth aspect, the bus bar plate and the opening valve cover are fastened together to the body at the fastening points. Therefore, the opening valve cover can easily be held stably in close contact with the degassing opening of the bus bar plate. The seal in the battery pack is thus more reliable. Fastening components together also makes it easier to reduce the number of components in the battery pack, thereby improving the productivity of the battery pack.

The power supply device according to the ninth aspect has a battery pack in which a bus bar plate is mounted onto the body stably at the opening portion.

### BRIEF DESCRIPTION OF THE DRAWINGS

In the accompanying drawings:

FIG. 1 is an external perspective view illustrating the inside of a power supply device according to an embodiment of this disclosure;

FIG. 2 is an exploded perspective view of each component inside the power supply device illustrated in FIG. 1;

FIG. 3 is a functional block diagram illustrating an overview of a power supply system that includes the power supply device illustrated in FIG. 1;

FIG. 4 is an external perspective view of the upper side of a four-cell stack assembly included in the power supply device illustrated in FIG. 1;

FIG. 5 is an external perspective view of the lower side of the four-cell stack assembly included in the power supply device illustrated in FIG. 1;

FIG. 6 illustrates the state of a bus bar plate as mounted on the body of the four-cell stack assembly illustrated in FIG. 4;

FIG. 7 is an exploded view of the body of the four-cell stack assembly illustrated in FIG. 4;

FIG. 8 is a front view of the bus bar plate included in the four-cell stack assembly illustrated in FIG. 4;

FIG. 9 illustrates the bus bar plate in FIG. 8 in a state with the bus bars removed;

FIG. 10 is an external perspective view at the back side of the opening valve cover illustrated in FIG. 6; and FIG. 11 is an external perspective view of the upper side of a one-cell stack assembly included in the power supply device illustrated in FIG. 1.

### DETAILED DESCRIPTION

Embodiments of this disclosure are described below in detail with reference to the drawings.

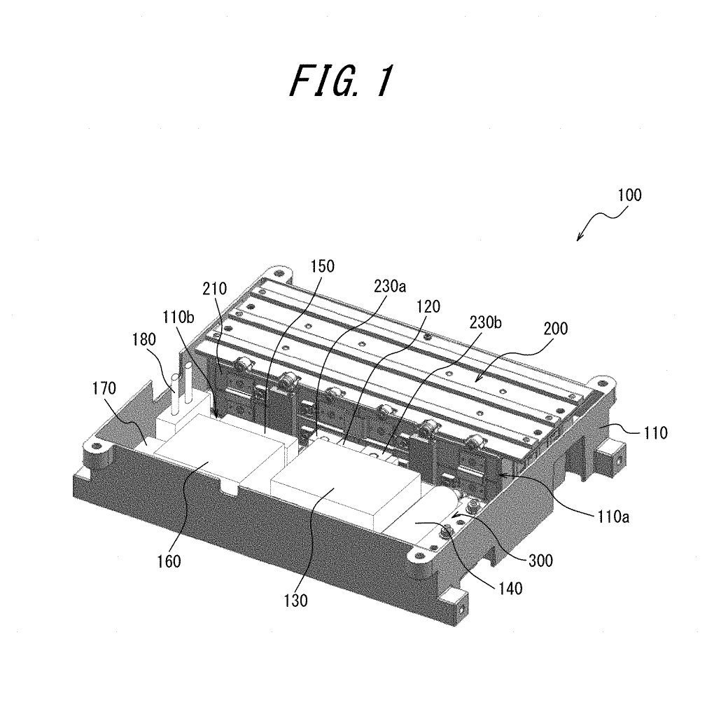

FIG. 1 is an external perspective view illustrating the inside of a power supply device according to an embodiment of this disclosure. A power supply device 100 is configured by a housing 110 open at the top side 110a and a non-illustrated lid capable of covering the top side 110a of the housing 110. FIG. 1 illustrates the power supply device 100 with the lid removed. The housing 110 is configured by a metal such as aluminum. The housing 110 and the lid sandwich a rubber seal made of ethylene-propylene-diene monomer (EPDM) rubber or the like and are joined by an appropriate method, such as screws or clamps. The housing 110 and the lid configure the power supply device 100 by the top side 110a of the housing 110 being covered by the lid. The power supply device 100 includes the necessary components inside. These components are, for example, connected electrically. In FIG. 1, a depiction of wiring is omitted to facilitate understanding. In the present embodiment, the power supply device 100 is described as being mounted and used in a vehicle provided with an internal combustion engine or in a vehicle such as a hybrid vehicle capable of running on power from both an internal combustion engine and an electric motor. The power supply device 100 is not, however, limited to being used in a vehicle.

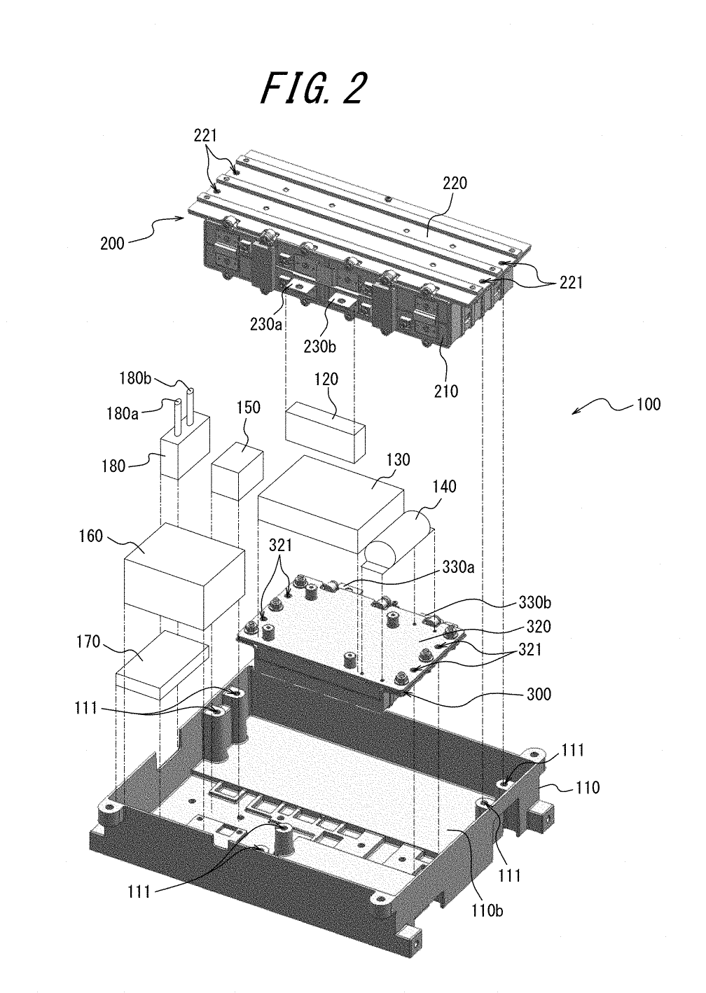

FIG. 2 is an exploded perspective view of each component inside the power supply device 100 illustrated in FIG. 1. As illustrated in FIG. 1 and FIG. 2, a substantially cuboid four-cell stack assembly 200 that includes a bus bar plate 210 on one surface and a substantially cuboid one-cell stack assembly 300 that includes a bus bar plate 310 on one surface are disposed in the housing 110 with the bus bar plate 210 and the bus bar plate 310 facing each other. In the present embodiment, the four-cell stack assembly 200 and the one-cell stack assembly 300 include respective holes 221 and 321 formed in restraining plates 220 and 320 provided at the upper portions thereof. The four-cell stack assembly 200 and the one-cell stack assembly 300 are fixed to the housing 110 by passing screws through the holes 221 and 321 and screwing the screws into holes 111 provided inside the housing 110.

The four-cell stack assembly 200 includes a positive electrode terminal 230a and a negative electrode terminal 230b that project from the bus bar plate 210. The one-cell stack assembly 300 includes a positive electrode terminal 330a and a negative electrode terminal 330b that project from the bus bar plate 310. In a state with the four-cell stack assembly 200 and the one-cell stack assembly 300 assembled with the housing 110, the negative electrode terminal 230b of the four-cell stack assembly 200 and the positive electrode terminal 330a of the one-cell stack assembly 300 are in contact.

The power supply device 100 includes a bus bar fixing terminal 120 that, in a state with the four-cell stack assembly 200 and the one-cell stack assembly 300 assembled with the housing 110, supports the positive electrode terminal 230a, the negative electrode terminal 230b, the positive electrode terminal 330a, and the negative electrode terminal 330b from the bottom 110b side.

A battery controller (LBC) 130 and a fusible link 140 are disposed at the upper portion of the one-cell stack assembly 300. The LBC 130 and the fusible link 140 are fixed to the upper portion of the one-cell stack assembly 300 with an appropriate method.

At a location on the bottom 110b of the housing 110 where the four-cell stack assembly 200 and the one-cell stack assembly 300 are not disposed, a current sensor 150, an inrush current reduction (ICR) relay 160, a metal oxide semiconductor field effect transistor (MOSFET) 170, and a terminal post 180 are provided. The current sensor 150, the ICR relay 160, the MOSFET 170, and the terminal post 180 are fixed to the bottom 110b of the housing 110 with an appropriate method. The terminal post 180 includes two terminals, for example.

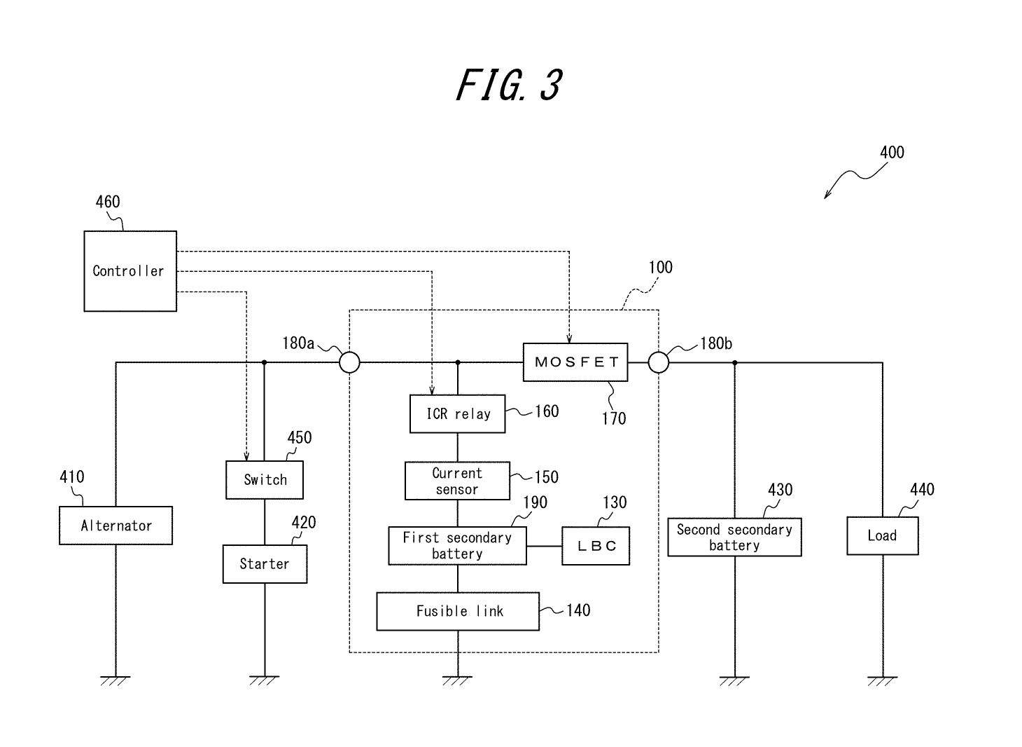

FIG. 3 is a functional block diagram illustrating an overview of a power supply system that includes the power supply device 100 illustrated in FIG. 1. A power supply system 400 includes the power supply device 100, an alternator 410, a starter 420, a second secondary battery 430, a load 440, a switch 450, and a controller 460. The power supply device 100 includes a first secondary battery 190 configured to include the four-cell stack assembly 200 and the one-cell stack assembly 300. The first secondary battery 190, the alternator 410, the starter 420, the second secondary battery 430, and the load 440 are connected in parallel.

In the power supply device 100, the ICR relay 160, the current sensor 150, the first secondary battery 190, and the fusible link 140 are connected in series in this order. In the power supply device 100, one terminal 180a of the terminal post 180 is connected to the alternator 410, and the other terminal 180b is connected to the load 440. The MOSFET 170 is connected in series with the second secondary battery 430 and the load 440.

The ICR relay 160 functions as a switch that connects or disconnects the first secondary battery 190 in parallel with constituent elements outside of the power supply device 100 in the power supply system 400.

The current sensor 150 has an appropriate structure and uses an appropriate method to measure current flowing over a path that includes the first secondary battery 190.

As described above, the first secondary battery 190 is configured to include the four-cell stack assembly 200 and the one-cell stack assembly 300. The first secondary battery 190 is, for example, a secondary battery such as a lithium-ion battery or a nickel-hydrogen battery. The first secondary battery 190 is connected to the current sensor 150 at the positive electrode side and to the fusible link 140 at the negative electrode side. In other words, the positive electrode terminal 230a of the four-cell stack assembly 200 is connected to the current sensor 150 and the negative electrode terminal 330b of the one-cell stack assembly 300 is connected to the fusible link 140 in the present embodiment.

The fusible link 140 is configured by a fuse body, a housing made of insulating resin for holding the fuse body, and a cover made of insulating resin for covering the housing. The fusible link 140 fuses when overcurrent occurs.

The MOSFET 170 functions as a switch that connects or disconnects the second secondary battery 430 and the load 440 in parallel with other constituent elements in the power supply system 400.

In the power supply device 100, the LBC 130 is connected to the first secondary battery 190 and estimates the state of the first secondary battery 190. For example, the LBC 130 estimates the state of charge (SOC) of the first secondary battery 190.

The alternator 410 is an electrical generator and is connected mechanically to the vehicle's engine. The alternator 410 generates electricity by being driven by the engine. The output voltage of the electrical power that the alternator 410 generates by being driven by the engine is adjusted by a regulator, and the electrical power is supplied to the first secondary battery 190 provided in the power supply device 100, the second secondary battery 430, the load 440, and non-illustrated auxiliary equipment in the vehicle. The alternator 410 can also generate electricity by regeneration, for example when the vehicle slows down. The electrical power that the alternator 410 generates by regeneration is used to charge the first secondary battery 190 and the second secondary battery 430.

The starter 420 is, for example, configured to include a cell motor, receives a power supply from at least one of the first secondary battery 190 and the second secondary battery 430, and starts the engine of the vehicle.

The second secondary battery 430 is configured by a lead storage battery, for example, and supplies electrical power to the load 440.

The load 440 is a load that, for example, includes the audio, air-conditioner, navigation system, and the like provided in the vehicle. The load 440 operates by consuming the supplied electrical power. The load 440 operates by receiving the electrical power supplied from the first secondary battery 190 while driving of the engine is suspended and operates by receiving the electrical power supplied from the alternator 410 and the second secondary battery 430 during driving of the engine.

The switch 450 is connected in series to the starter 420. The switch 450 connects or disconnects the starter 420 in parallel with other constituent elements.

The controller 460 controls overall operations of the power supply system 400. The controller 460 is, for example, configured by the electric control unit or engine control unit (ECU) of the vehicle. The controller 460 controls operations of the switch 450, the ICR relay 160, and the MOSFET 170. In this manner, the controller 460 supplies power with the alternator 410, the first secondary battery 190, and the second secondary battery 430 and also charges the first secondary battery 190 and the second secondary battery 430.

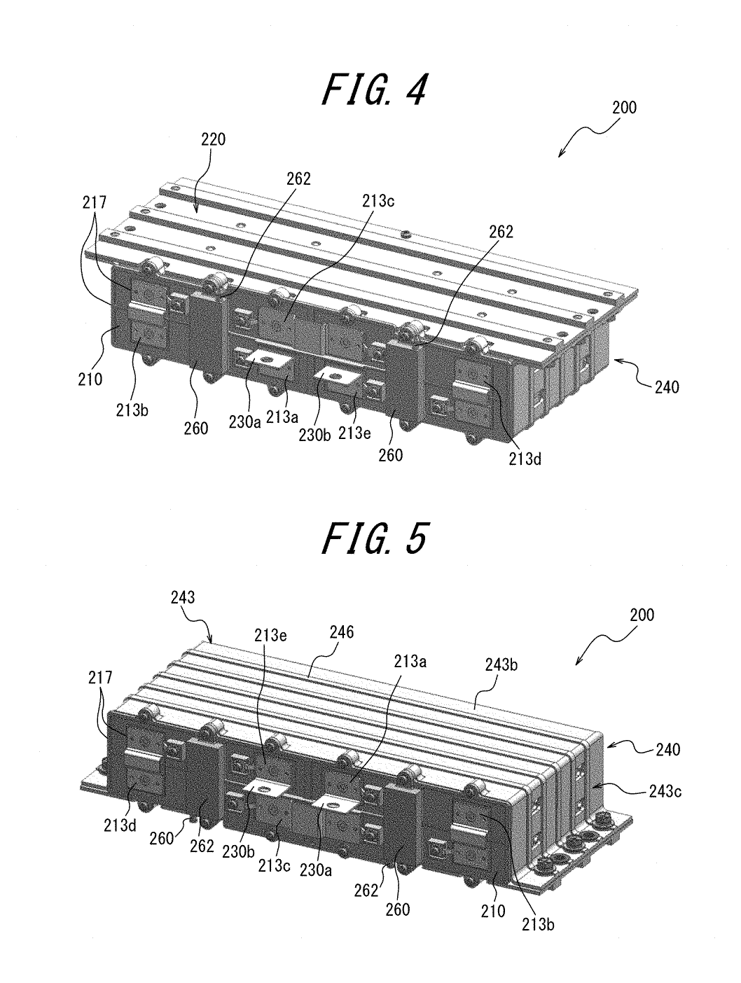

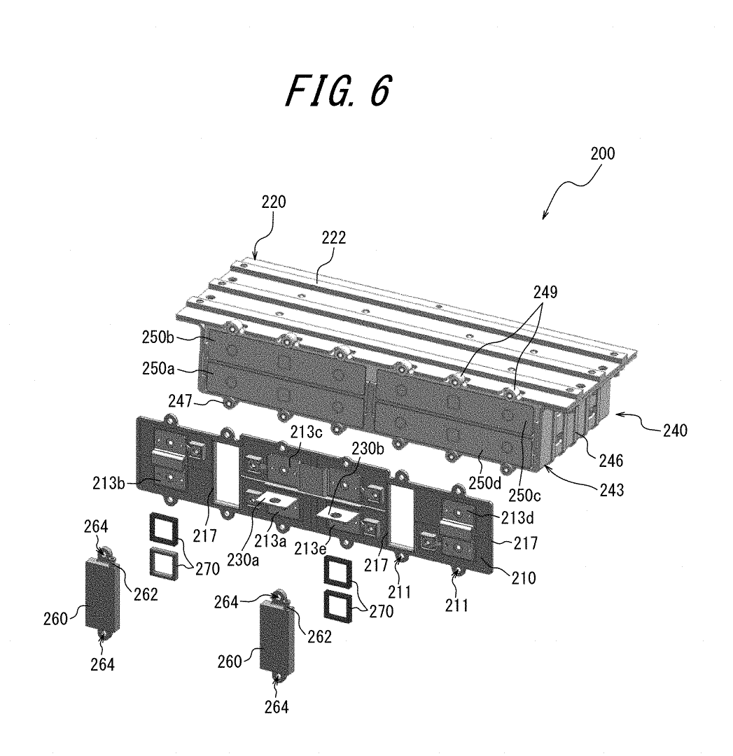

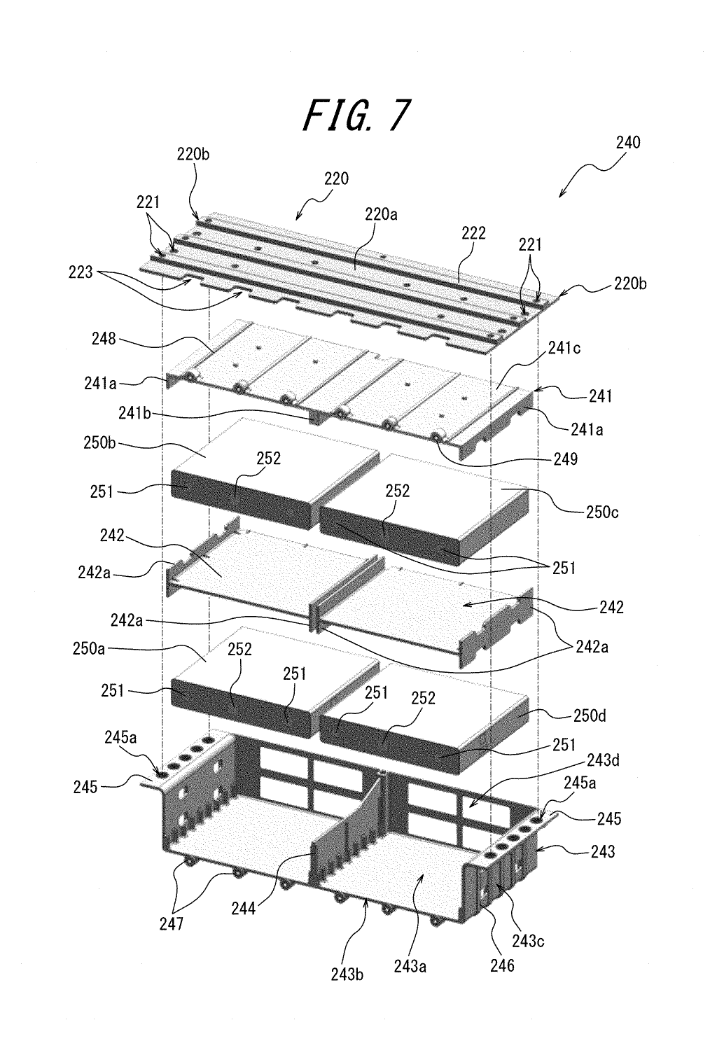

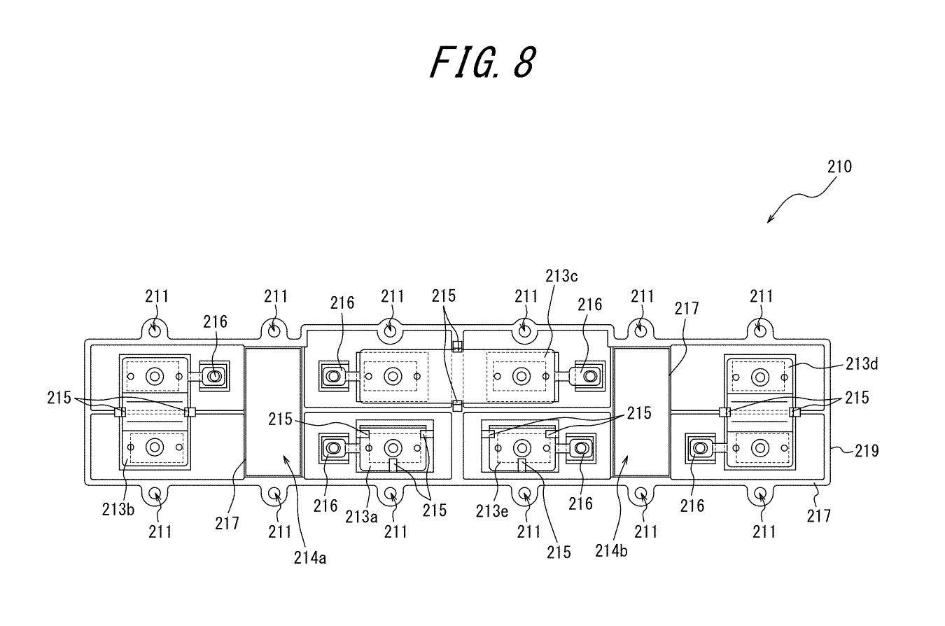

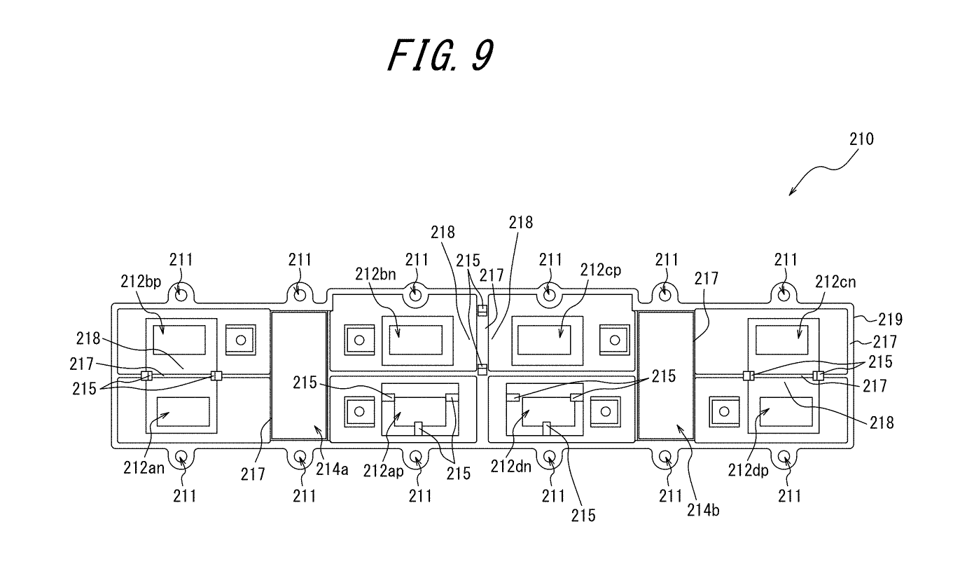

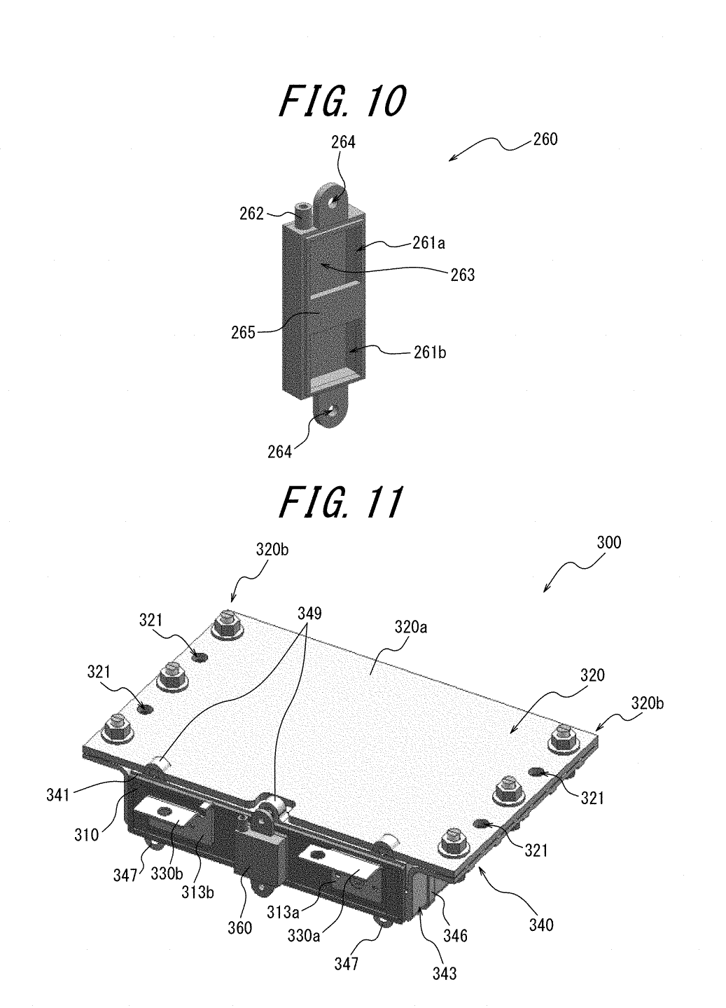

Next, with reference to FIG. 4 through FIG. 10, the four-cell stack assembly 200 that is a battery pack according to an embodiment of this disclosure is described in detail. FIG. 4 is an external perspective view of the upper side of the four-cell stack assembly 200 included in the power supply device 100 illustrated in FIG. 1. FIG. 5 is an external perspective view of the lower side of the four-cell stack assembly 200 included in the power supply device 100 illustrated in FIG. 1. FIG. 6 illustrates the state of the bus bar plate 210 as mounted on the body of the four-cell stack assembly 200 illustrated in FIG. 4. FIG. 7 is an exploded view of the body of the four-cell stack assembly 200 illustrated in FIG. 4. FIG. 8 is a front view of the bus bar plate 210 included in the four-cell stack assembly 200 illustrated in FIG. 4, i.e. of the bus bar plate 210 according to an embodiment of this disclosure. FIG. 9 illustrates the bus bar plate 210 in FIG. 8 in a state with the bus bars removed. FIG. 10 is an external perspective view at the back side of the opening valve cover illustrated in FIG. 6.

As illustrated in FIG. 6, the four-cell stack assembly 200 is configured by mounting the bus bar plate 210 onto a body 240 that holds batteries 250a, 250b, 250c, and 250d. The bus bar plate 210 is mounted onto the body 240 at fastening points so as to cover the electrodes of the batteries 250a, 250b, 250c, and 250d. The side of the four-cell stack assembly 200 to which the bus bar plate 210 is mounted is described below as the front. In the present embodiment, the body 240 holds a total of four batteries 250a, 250b, 250c, and 250d in two upper and lower rows and two left and right rows. When looking at the front of the body 240, the battery disposed to the lower left is 250a, the battery disposed to the upper left is 250b, the battery disposed to the upper right is 250c, and the battery disposed to the lower right is 250d. When not distinguishing between the batteries, the batteries are referred to collectively as batteries 250.

As illustrated in FIG. 7, the body 240 is constituted by sandwiching the batteries 250 between an upper case 241 and a lower case 243 and mounting a restraining plate 220 onto the upper side of the upper case 241. An intermediate case 242 is inserted between the two upper and lower rows of batteries 250. The body 240 is substantially cuboid and has a shorter depth in the front and back direction than the width in the lateral direction. The upper case 241, the intermediate case 242, and the lower case 243 are each configured by a resin such as polybutylene terephthalate (PBT). The restraining plate 220 is configured by a metal such as aluminum.

The batteries 250 are, for example, secondary batteries such as a lithium-ion battery or a nickel-hydrogen battery. The batteries 250 are held in the body 240 so that the electrodes 251 face the front. In the present embodiment, each battery 250 has a positive electrode and a negative electrode at both ends in the front view of the body 240. In the front view of the body 240, the lower batteries 250a and 250d are held in the body 240 so that the positive electrodes are at the right end, and the upper batteries 250b and 250c are held in the body 240 so that the positive electrodes are at the left end. In each battery 250, a gas escape hole 252 for emitting gas produced in the battery 250 to the outside is provided at the center between the positive electrode and the negative electrode in the front view of the body 240.

In the front view, the lower case 243 has a concave shape with a space 243a capable of housing the batteries 250 and has a separating plate 244 at the center for separating the batteries 250 housed to the left and right. The lower case 243 has a flange 245 that projects towards the outside of the lower case 243 (towards the opposite side from the space 243a) at the upper edge of side faces 243c.

A plurality of holes 245a that pass through the flange 245 are provided in the flange 245. These holes 245a are provided at positions that correspond to the holes 221 in the restraining plate 220 when the body 240 is assembled. A portion of the holes 245a is used to fix the lower case 243 and the restraining plate 220 by screwing. Another portion of the holes 245a is used for screws to pass through and screw the body 240, including the restraining plate 220, to screw holes 111 provided inside the housing 110.

As illustrated in FIG. 5, the lower case 243 has beads 246 projecting from a bottom 243b and extending along the bottom 243b in the longitudinal direction (width direction). The beads 246 extend from the bottom 243b along the side face 243c up to the height of the flange 245. The beads 246 improve the rigidity in the longitudinal direction of the lower case 243 and the body 240.

The lower case 243 has a plurality of screw hole formation portions 247, the front sides of which are open, on the bottom 243b. The screw hole formation portions 247 are provided projecting downwards from the bottom 243b of the lower case 243. In the present embodiment, the lower case 243 has six screw hole formation portions 247. Specifically, the six screw hole formation portions 247 are provided at the positions closest to four electrodes 251 and two gas escape holes 252 of the lower batteries 250a and 250d when the body 240 is in an assembled state. Screw holes provided in the screw hole formation portions 247 are used for screwing the bus bar plate 210 to the body 240. In other words, the screw hole formation portions 247 constitute fastening points.

The intermediate case 242 is a plate-shaped member for separating the batteries 250 provided in the upper and lower rows. One intermediate case 242 is inserted for each pair of upper and lower batteries 250 in the body 240. In other words, the body 240 of the present embodiment includes two intermediate cases 242. The width of the each intermediate case 242 is equivalent to the inner width from the side face 243c of the lower case 243 to the separating plate 244. The intermediate case 242 includes flanges 242a to the left and right to allow stable arrangement in the space 243a of the lower case 243. The intermediate case 242 is thus formed in an H shape in front view. The flanges 242a have the function of stabilizing and holding the batteries 250 in the space 243a.

The upper case 241 is mounted on the upper portion of the two rows of batteries 250 housed in the lower case 243. The width of the upper case 241 is equivalent to the inner width between the side faces 243c of the lower case 243. The upper case 241 has flanges 241a on the left and right that project towards the bottom 243b of the lower case 243 and has a separating plate 241b that projects towards the bottom 243b of the lower case 243 at the center. The upper case 241 is stably disposed inside the space 243a of the lower case 243 by the lateral flanges 241a. Furthermore, the upper case 241 can stably hold the batteries 250 in the space 243a with the lateral flanges 241a and the separating plate 241b.

The upper case 241 has beads 248 projecting from an upper surface 241c and extending along the upper surface 241c in the transverse direction (depth direction). The beads 248 improve the rigidity in the transverse direction of the upper case 241 and the body 240.

The upper case 241 has a plurality of screw hole formation portions 249, the front sides of which are open, on the upper surface 241c. The screw hole formation portions 249 are provided projecting upwards from the upper surface 241c. In the present embodiment, the upper case 241 has six screw hole formation portions 249. Specifically, the six screw hole formation portions 249 are provided at the positions closest to four electrodes 251 and two gas escape holes 252 of the upper batteries 250b and 250c when the body 240 is in an assembled state. Screw holes provided in the screw hole formation portions 249 are used for screwing the bus bar plate 210 to the body 240. In other words, the screw hole formation portions 249 constitute fastening points.

The restraining plate 220 is a substantially flat plate. The width of the restraining plate 220 is equivalent to the width that includes the flanges 245 of the lower case 243. The depth of the restraining plate 220 is equivalent to the depth of the lower case 243. In other words, the restraining plate 220 is formed to cover the entire body 240 in the top view of the body 240. On the front side, notches 223 are provided in the restraining plate 220 at positions corresponding to the screw hole formation portions 249 of the upper case 241. When the restraining plate 220 is fixed to the upper case 241, the notches 223 prevent interference between the restraining plate 220 and the screw hole formation portions 249 that project upwards from the upper surface 241c and facilitate close contact between the restraining plate 220 and the upper surface 241c of the upper case 241.

On lateral ends 220b, the restraining plate 220 has a plurality of holes 221 that pass through the restraining plate 220. A portion of the holes 221 is used to fix the lower case 243 and the restraining plate 220 by screwing. Another portion of the holes 221 is used for screws to pass through and screw the body 240, including the restraining plate 220, to screw holes 111 provided inside the housing 110.

The restraining plate 220 has beads 222 projecting from a top 220a and extending along the top 220a in the longitudinal direction (width direction). The beads 222 improve the rigidity in the longitudinal direction of the restraining plate 220 and the body 240.

The bus bar plate 210 is mounted on the assembled body 240 from the front side, as illustrated in FIG. 6. The bus bar plate 210 is configured by resin, for example, such as PBT.

As illustrated in FIG. 8, the bus bar plate 210 is a substantially rectangular flat plate that has a plurality of bus bar plate mounting holes 211 on an outer peripheral edge 219 thereof. The bus bar plate mounting holes 211 are provided on the outer peripheral edge 219 of the bus bar plate 210 at close positions to the peripheral edge of the below-described degassing openings and electrode openings included in the bus bar plate. Here, close positions refer to positions at which the distance from the peripheral edge of the degassing openings and electrode openings to the outer peripheral edge 219 of the bus bar plate 210 is shorter than a predetermined distance. The bus bar plate mounting holes 211 are particularly preferably provided at locations for which the distance from the peripheral edge of the degassing openings and electrode openings to the outer peripheral edge 219 of the bus bar plate 210 is closest. In the present embodiment, the bus bar plate mounting holes 211 are provided at positions in the bus bar plate 210 corresponding to the screw hole formation portions 247 or 249 once the bus bar plate 210 is mounted on the body 240. In other words, six bus bar plate mounting holes 211 are provided on each of the upper and lower long sides of the bus bar plate 210. The bus bar plate 210 is mounted onto the body 240 by passing screws through the bus bar plate mounting holes 211 and screwing the screws into screw holes provided in the screw hole formation portions 247 or 249. In other words, the bus bar plate mounting holes 211 constitute fastening points.

As illustrated in FIG. 9, the bus bar plate 210 has electrode openings at positions corresponding to the electrodes of the batteries 250 once the bus bar plate 210 is mounted on the body 240. In other words, the bus bar plate 210 has a total of eight electrode openings. The electrode openings corresponding to the positive electrode and negative electrode of the battery 250a are referred to respectively as a first electrode opening 212ap and a second electrode opening 212an. The electrode openings corresponding to the positive electrode and negative electrode of the battery 250b are referred to respectively as a third electrode opening 212bp and a fourth electrode opening 212bn. The electrode openings corresponding to the positive electrode and negative electrode of the battery 250c are referred to respectively as a fifth electrode opening 212cp and a sixth electrode opening 212cn. The electrode openings corresponding to the positive electrode and negative electrode of the battery 250d are referred to respectively as a seventh electrode opening 212dp and an eighth electrode opening 212dn. When not distinguishing between the electrode openings, the electrode openings are referred to collectively as electrode openings 212. The bus bar plate 210 includes a bus bar on each electrode opening 212 on the front side.

Furthermore, the bus bar plate 210 has degassing openings at positions corresponding to the gas escape holes 252 of the batteries 250 once the bus bar plate 210 is mounted on the body 240. In the present embodiment, one degassing opening is provided at a position corresponding to the gas escape holes 252 of two batteries 250 in the upper and lower rows. In other words, a degassing opening 214a is provided at a position corresponding to the gas escape holes 252 of the batteries 250a and 250b. A degassing opening 214b is provided at a position corresponding to the gas escape holes 252 of the batteries 250c and 250d. However, a total of four degassing openings may instead be provided in the bus bar plate 210 for one-to-one correspondence with the gas escape holes 252 of the batteries.

In the body 240, the bus bar plate mounting holes 211 are provided at the closest positions to the corresponding electrode openings 212 or degassing openings 214a, 214b on the basis of the positional relationships between the above-described screw hole formation portions 247 and 249 on the one hand and the electrodes 251 and gas escape holes 252 of the batteries 250 on the other. When not distinguishing between the degassing openings 214a and 214b, the degassing openings are referred to collectively as degassing openings 214.

As illustrated in FIG. 8, the bus bar plate 210 includes a first bus bar 213a on the first electrode opening 212ap. As illustrated in FIG. 6, the first bus bar 213a has two orthogonal surfaces. One surface is held by three holding claws 215 provided on the bus bar plate 210, and the other surface projects from the bus bar plate 210 towards the front, constituting the positive electrode terminal 230a. The positive electrode terminal 230a constituted by the first bus bar 213a is connected to the current sensor 150. After the bus bar plate 210 is mounted on the body 240, the surface of the first bus bar 213a not constituting the positive electrode terminal 230a is connected to the positive electrode of the battery 250a by laser welding. The holding claws 215 also have the function of temporarily holding the first bus bar 213a before the laser welding. The first bus bar 213a also has a terminal 216 for connecting the current sensor.

Furthermore, as illustrated in FIG. 8, the bus bar plate 210 includes a second bus bar 213b that extends vertically across the second electrode opening 212an and the third electrode opening 212bp. In other words, the second bus bar 213b connects the negative electrode of the battery 250a and the positive electrode of the battery 250b once the bus bar plate 210 is mounted on the body 240. The second bus bar 213b is held by two holding claws 215 provided on the bus bar plate 210. After the bus bar plate 210 is mounted on the body 240, the second bus bar 213b is connected to the negative electrode of the battery 250a at the second electrode opening 212an by laser welding and is connected to the positive electrode of the battery 250b at the third electrode opening 212bp by laser welding. The holding claws 215 also have the function of temporarily holding the second bus bar 213b before the laser welding. The second bus bar 213b also has a terminal 216 for connecting the current sensor.

Furthermore, as illustrated in FIG. 8, the bus bar plate 210 includes a third bus bar 213c that extends horizontally across the fourth electrode opening 212bn and the fifth electrode opening 212cp. In other words, the third bus bar 213c connects to the negative electrode of the battery 250b and the positive electrode of the battery 250c once the bus bar plate 210 is mounted on the body 240. The third bus bar 213c is held by two holding claws 215 provided on the bus bar plate 210. After the bus bar plate 210 is mounted on the body 240, the third bus bar 213c is connected to the negative electrode of the battery 250b at the fourth electrode opening 212bn by laser welding and is connected to the positive electrode of the battery 250c at the fifth electrode opening 212cp by laser welding. The holding claws 215 also have the function of temporarily holding the third bus bar 213c before the laser welding. On the left side of the fourth electrode opening 212bn and on the right side of the fifth electrode opening 212cp, the third bus bar 213c also has respective terminals 216 for connecting the current sensor.

Furthermore, as illustrated in FIG. 8, the bus bar plate 210 includes a fourth bus bar 213d that extends vertically across the sixth electrode opening 212cn and the seventh electrode opening 212dp. In other words, the fourth bus bar 213d connects the negative electrode of the battery 250c and the positive electrode of the battery 250d once the bus bar plate 210 is mounted on the body 240. The fourth bus bar 213d is held by two holding claws 215 provided on the bus bar plate 210. After the bus bar plate 210 is mounted on the body 240, the fourth bus bar 213d is connected to the negative electrode of the battery 250c at the sixth electrode opening 212cn by laser welding and is connected to the positive electrode of the battery 250d at the seventh electrode opening 212dp by laser welding. The holding claws 215 also have the function of temporarily holding the fourth bus bar 213d before the laser welding. The fourth bus bar 213d also has a terminal 216 for connecting the current sensor.

Furthermore, as illustrated in FIG. 8, the bus bar plate 210 includes a fifth bus bar 213e on the eighth electrode opening 212dn. As illustrated in FIG. 6, the fifth bus bar 213e has two orthogonal surfaces. One surface is held by three holding claws 215 provided on the bus bar plate 210, and the other surface projects from the bus bar plate 210 towards the front, constituting the negative electrode terminal 230b. The negative electrode terminal 230b constituted by the fifth bus bar 213e is connected to the positive electrode terminal of the one-cell stack assembly 300. After the bus bar plate 210 is mounted on the body 240, the surface of the fifth bus bar 213e not constituting the negative electrode terminal 230b is connected to the negative electrode of the battery 250e by laser welding. The holding claws 215 also have the function of temporarily holding the fifth bus bar 213e before the laser welding. The fifth bus bar 213e also has a terminal 216 for connecting the current sensor.

The first bus bar 213a through the fifth bus bar 213e are each configured by a conductive metal such as aluminum.

The bus bar plate 210 has a bead 217 that projects towards the front along the entire outer peripheral edge 219. The bus bar plate 210 also has beads 217 that project towards the front along the entire peripheral edge of the degassing openings 214.

Furthermore, at the bus bars that are arranged across two electrode openings, the bus bar plate 210 has a bead 217 that projects towards the front on a plate portion 218 between the two electrode openings. In other words, as illustrated in FIG. 9, the bus bar plate 210 in this embodiment has a bead 217 on a plate portion 218 between the second electrode opening 212an and the third electrode opening 212bp in the second bus bar 213b arranged across the second electrode opening 212an and the third electrode opening 212bp. The bus bar plate 210 also has a bead 217 on a plate portion 218 between the fourth electrode opening 212bn and the fifth electrode opening 212cp in the third bus bar 213c arranged across the fourth electrode opening 212bn and the fifth electrode opening 212cp. The bus bar plate 210 also has a bead 217 on a plate portion 218 between the sixth electrode opening 212cn and the seventh electrode opening 212dp in the fourth bus bar 213d arranged across the sixth electrode opening 212cn and the seventh electrode opening 212dp.

Providing the beads 217 in the bus bar plate 210 in this manner improves the rigidity of the bus bar plate 210 and the four-cell stack assembly overall.

The four-cell stack assembly 200 includes opening valve covers 260 on the degassing openings 214 of the bus bar plate 210. The opening valve covers 260 are, for example, constituted by resin such as PBT. As illustrated in FIG. 10, each opening valve cover 260 has openings 261a and 261b that cover the degassing opening 214 at the back side in the assembled state of the four-cell stack assembly 200. The opening 261a and the opening 261b are separated by a separating plate 265. The openings 261a and 261b separated by the separating plate 265 cover the gas escape hole 252 of each battery 250 when the opening valve covers 260 are assembled into the four-cell stack assembly 200.

The opening valve cover 260 is substantially cuboid and has an interior space 263. The opening valve cover 260 has a substantially cylindrical gas emission duct 262 that connects the interior space 263 with the outside of the opening valve cover 260. A non-illustrated hose is connected to the gas emission duct 262. The gasses emitted from the inside of the batteries 250 flow into the interior space 263 of the opening valve cover 260 through the openings 261a and 261b and combine. The combined gas then passes through the gas emission duct 262 and is emitted to the outside from the hose connected to the gas emission duct 262.

The opening valve cover 260 includes a plurality of opening valve cover mounting holes 264. In the present embodiment, the opening valve cover 260 is mounted onto the body 240 by passing screws through the opening valve cover mounting holes 264 and the bus bar plate mounting holes 211 corresponding to the degassing openings 214 of the bus bar plate 210 and screwing the screws into screw holes provided in the screw hole formation portions 247 or 249. Accordingly, the opening valve cover mounting holes 264 are provided at positions corresponding to the bus bar plate mounting holes 211 that correspond to the degassing openings 214, and the opening valve cover mounting holes 264 constitute fastening points. The outer circumferential dimension of the opening valve cover 260 in front view preferably allows engagement in close contact with the bead 217 provided on the degassing opening 214. In this manner, the bead 217 and the opening valve cover 260 are in close contact when the four-cell stack assembly 200 is in an assembled state. The gas emitted from the batteries 250 can therefore be prevented from flowing outside of the four-cell stack assembly 200.

The opening valve cover 260 is mounted onto the body 240 by being screwed thereon with seals 270 made of rubber, such as EPDM, sandwiched by the openings 261a and 261b to prevent gas from leaking to the outside from the opening valve cover 260.

Next, the one-cell stack assembly 300 is described. FIG. 11 is an external perspective view of the upper side of the one-cell stack assembly 300 included in the power supply device 100 illustrated in FIG. 1. Since the configuration of the one-cell stack assembly 300 is similar to that of the four-cell stack assembly 200, a description is omitted as appropriate for locations identical to the four-cell stack assembly 200.

Like the four-cell stack assembly 200, the one-cell stack assembly 300 is configured by mounting the bus bar plate 310 onto a body 340 that holds a battery. The bus bar plate 310 is mounted onto the body 340 at fastening points so as to cover the electrodes of the battery held by the body 340.

The body 340 of the one-cell stack assembly 300 includes only one battery. The battery is sandwiched by an upper case 341 and a lower case 343. The lower case 343 has beads 346 that extend along the bottom in the width direction. The beads 346 extend to the side faces of the lower case 343. The upper case 341 and the lower case 343 have screw hole formation portions 347 and 349 for fixing the bus bar plate 310 by screwing. In other words, the screw hole formation portions 347 and 349 constitute fastening points.

A restraining plate 320 is disposed on the top of the upper case 341. The restraining plate 320 is fastened to the lower case 343 by screwing, using a portion of holes 321 provided on ends 320b of the restraining plate 320 and holes provided on a flange of the lower case 343. The top 320a of the restraining plate 320 does not have any beads, thereby facilitating mounting of the LBC 130 and the fusible link 140 upon assembly into the power supply device 100.

The bus bar plate 310 is a substantially rectangular flat plate that has a plurality of bus bar plate mounting holes on an outer peripheral edge thereof. The bus bar plate mounting holes of the bus bar plate 310 are provided at positions in the bus bar plate 310 corresponding to the screw hole formation portions 347 or 349 once the bus bar plate 310 is mounted on the body 340.

The bus bar plate 310 has electrode openings at positions corresponding to the positive electrode and the negative electrode of the battery once the bus bar plate 310 is mounted on the body 340. The bus bar plate 310 has a sixth bus bar 313a at the electrode opening corresponding to the positive electrode of the battery. As illustrated in FIG. 11, the sixth bus bar 313a has two orthogonal surfaces. One surface is held by three holding claws provided on the bus bar plate 310, and the other surface projects from the bus bar plate 310 towards the front, constituting the positive electrode terminal 330a. The positive electrode terminal 330a constituted by the sixth bus bar 313a is connected to the negative electrode terminal 230b of the four-cell stack assembly 200.

The bus bar plate 310 also has a seventh bus bar 313b at the electrode opening corresponding to the negative electrode of the battery. As illustrated in FIG. 11, the seventh bus bar 313b has two orthogonal surfaces. One surface is held by three holding claws provided on the bus bar plate 310, and the other surface projects from the bus bar plate 310 towards the front, constituting the negative electrode terminal 330b. The negative electrode terminal 330b constituted by the seventh bus bar 313b is connected to the fusible link 140.

Furthermore, the bus bar plate 310 has degassing openings at positions corresponding to gas escape holes of the battery once the bus bar plate 310 is mounted on the body 340. Like the bus bar plate 210 of the four-cell stack assembly 200, an opening valve cover 360 is mounted on the degassing openings of the bus bar plate 310.

In this manner, the four-cell stack assembly 200 (battery pack) according to the present embodiment is assembled by passing screws through the bus bar plate mounting holes 211 of the bus bar plate 210, which are fastening points, and screwing the screws into screw holes formed by the screw hole formation portions 247 and 249 of the body 240. The fastening points are provided on the outer peripheral portion of the bus bar plate 210 at positions near the peripheral edge of the degassing openings 214 and the electrode openings 212 that the bus bar plate 210 has, thereby reducing the distance between the fastening points and each opening as compared to when the fastening points are provided at a different position. Therefore, the bus bar plate 210 can be stably mounted onto the body 240 at each opening portion.

Furthermore, in the four-cell stack assembly 200 (battery pack) according to the present embodiment, the opening valve cover 260 is also mounted onto the body 240 by being fastened together with the bus bar plate 210 at the fastening points. Therefore, the opening valve cover 260 can easily be held stably in close contact with the degassing openings 214 of the bus bar plate 210. The seal in the battery pack is thus more reliable. Fastening components together also makes it easier to reduce the number of components in the battery pack, thereby improving the productivity of the battery pack.

Furthermore, since the bus bar plate 210 has holding claws 215 for temporarily holding the bus bars, the battery pack is easier to assemble.

The beads on the outer peripheral edge 219, the peripheral edge of the degassing openings 214, and the plate portions 218 of the bus bar plate 210 increase the rigidity of the bus bar plate 210 and increase the overall rigidity of the battery pack on which the bus bar plate 210 is mounted.

Although this disclosure is based on embodiments and drawings, it is to be noted that various changes and modifications will be apparent to those skilled in the art based on this disclosure. Therefore, such changes and modifications are to be understood as included within the scope of this disclosure. For example, the functions and the like included in the various components may be reordered in any logically consistent way. Furthermore, components may be combined into one or divided.

For example, in the above embodiment, the case of the battery pack being the four-cell stack assembly 200 that includes four batteries 250 has been described, but the battery pack is not limited to the four-cell stack assembly 200. The battery pack can be configured to include any number, two or greater, of batteries 250.

Furthermore, the bus bar plate 210 may, for example, have a bead at a location other than the outer peripheral edge 219, the peripheral edge of the degassing openings 214, and the plate portions 218. For example, the bus bar plate 210 may have beads 217 that project towards the front along the entire peripheral edge of the electrode openings 212.

### REFERENCE SIGNS LIST

100 Power supply device

110 Housing

110a Top

110b Bottom

111 Screw hole

120 Bus bar fixing terminal

130 LBC (battery controller)

140 Fusible link

150 Current sensor

160 ICR relay

170 MOSFET

180 Terminal post

180a, 180b Terminal

190 First secondary battery

200 Four-cell stack assembly

210, 310 Bus bar plate

211 Bus bar plate mounting hole

212 Electrode opening

212ap First electrode opening

212an Second electrode opening

212bp Third electrode opening

212bn Fourth electrode opening

212cp Fifth electrode opening

212cn Sixth electrode opening

212dp Seventh electrode opening

212dn Eighth electrode opening

213a First bus bar

213b Second bus bar

213c Third bus bar

213d Fourth bus bar

213e Fifth bus bar

214, 214a, 214b Degassing opening

215 Holding claw

216 Terminal

217, 246, 248, 346 Bead

218 Plate portion

219 Outer peripheral edge

220, 320 Restraining plate

220a, 320a Top

220b, 320b End

221, 321 Hole

222 Bead

223 Notch

230a, 330a Positive electrode terminal

230b, 330b Negative electrode terminal

240, 340 Body

241, 341 Upper case

241a, 242a, 245 Flange

241b, 244, 265 Separating plate

241c Top

242 Intermediate case

243, 343 Lower case

243a, 263 Space

243b Bottom

243c Side face

245a Hole

247, 249, 347 Screw hole formation portion

250 Battery

251 Electrode

252 Gas escape hole

260, 360 Opening valve cover

261a, 261b Opening

262 Gas emission duct

264 Opening valve cover mounting hole

270 Seal

300 One-cell stack assembly

313a Sixth bus bar

313b Seventh bus bar

400 Power supply system

410 Alternator

420 Starter

430 Second secondary battery

440 Load

450 Switch

460 Controller

1. A battery pack comprising:
a body comprising a plurality of batteries; and
a bus bar plate mounted onto the body at a fastening point so as to cover electrodes of the batteries, wherein
the bus bar plate comprises an opening, and the fastening point is provided on an outer peripheral edge of the bus bar plate at a position near a peripheral edge of the opening.

2. The battery pack of claim 1, wherein the opening is a degassing opening provided at a position corresponding to a gas escape hole of the batteries once the bus bar plate is mounted onto the body.

3. The battery pack of claim 1, wherein the opening is an electrode opening provided at positions corresponding to the electrodes of the batteries once the bus bar plate is mounted onto the body.

4. The battery pack of claim 1, wherein the bus bar plate comprises a holding claw to hold a bus bar.

5. The battery pack of claim 1, wherein the bus bar plate comprises a bead on the outer peripheral edge.

6. The battery pack of claim 1, wherein the bus bar plate comprises a bead on the peripheral edge of the opening.

7. The battery pack of claim 3, wherein at a bus bar arranged across a plurality of the electrode openings, the bus bar plate comprises a bead on a plate portion between the plurality of the electrode openings.

8. The battery pack of claim 2, further comprising an opening valve cover to be mounted over the degassing opening onto the body along with the bus bar plate at the fastening point.

9. A power supply device comprising the battery pack of claim 1.
